(19) United States
(12) Patent Application Publication
(10) Pub. No.: US 2012/0320725 A1
(43) Pub. Date: Dec. 20, 2012

(54) OPTICAL RECORDING MEDIUM DRIVING APPARATUS, HIGH FREQUENCY SUPERPOSITION METHOD, AND PROGRAM

(75) Inventors: Seiichirou Miyaki, Tokyo (JP); Tomoya Ozaki, Kanagawa (JP)

(73) Assignee: SONY CORPORATION, Tokyo (JP)

(21) Appl. No.: 13/489,868

(22) Filed: Jun. 6, 2012

(30) Foreign Application Priority Data
Jun. 16, 2011 (JP) 2011-134014

(51) Int. Cl. G11B 7/12

(52) U.S. Cl. 369/47.53; G9B/7.097

(57) ABSTRACT

An optical recording medium driving apparatus includes: a driving signal generating unit that generates a driving signal for driving a laser beam source; a high frequency superposition unit that performs high frequency superposition on the driving signal; a light receiving unit that receives an optical feedback of a laser beam; an evaluation signal generating unit that generates an evaluation signal from a light reception signal; a storage unit that stores first high frequency superposition amount information corresponding to a high frequency superposition amount for a normal reproduction mode and second high frequency superposition amount information corresponding to an amount that is greater than that represented by the first high frequency superposition amount information; and a superposition amount control unit that performs control so that a high frequency superposition amount based on the second high frequency superposition amount information is set when measuring an evaluation index based on the evaluation signal.

### CROSS-REFERENCE TO RELATED APPLICATION

The present application claims priority from Japanese Patent Application No. JP 2011-134014 filed in the Japanese Patent Office on Jun. 16, 2011, the entire content of which is incorporated herein by reference.

### BACKGROUND

The present technology relates to an optical recording medium driving apparatus having an ability to perform high frequency superposition on a laser driving current as an optical recording medium driving apparatus configured to perform at least reproduction from an optical recording medium, and to a high frequency superposition method thereof. The present technology also relates to a program to be executed by the optical recording medium driving apparatus above.

Optical disc recording media (hereinafter, also referred to as “optical disc(s)”) including, for example, compact discs (CDs), digital versatile discs (DVDs), and Blu-ray (BD, registered trademark) discs, are widely used.

When driving a laser for light-emission at a power level as low as a read power level, some of optical recording medium driving apparatuses, configured to perform recording and reproducing optical discs as listed above, perform high frequency superposition on a laser driving current, so that optical feedback noise is reduced and a stable emission operation can be realized (see, for example, Patent Document 1 listed below).

In such optical recording medium driving apparatuses, however, if an amount of high frequency superposition (hereinafter also referred to as “high frequency superposition amount”) is too low, the problems arise that data reproducibility deteriorates, and that a scoop ratio (i.e., a variation rate of laser beam emission amount with respect to a leaser beam reflection amount caused by a recording mark and a space portion) increases, so that it becomes difficult to accurately measure a β value, a modulation factor, and other evaluation indexes associated with quality of recording signals, etc.

In this sense, it seems that a greater high frequency superposition amount is desirable.

However, increasing an amount of high frequency superposition causes another problem that unnecessary radiation noise increases. For this reason, usually a high frequency superposition amount is set in view of a trade-off with unnecessary radiation noise.

Patent Document 1: Japanese Patent Application Laid-open No. 2000-149302

### SUMMARY

Taking into account unnecessary radiation noise, it is likely that a rather small high-frequency superposition amount is selected while allowing for a relatively large margin for noise, for compliance with applicable standards, rules, and conventions.

In such a case, however, it may happen that a scoop ratio cannot be sufficiently reduced, so that evaluation indexes such as a β value and a modulation factor as mentioned above cannot be accurately measured.

In view of the aforementioned problem, the present technology has been developed towards realizing more accurate measurement of an evaluation index such as aβ Value and a modulation factor, an accuracy of measurement of which deteriorates with increase in scoop ratio, while complying with applicable standards, rules, and conventions regarding unnecessary radiation noise.

To solve the problems above, an optical recording medium driving apparatus according to an embodiment of the present technology is configured as follows.

The optical recording medium driving apparatus according to the embodiment includes a driving signal generating unit configured to generate a driving signal for driving a laser beam source for emission.

The optical recording medium driving apparatus further includes a high frequency superposition unit configured to perform high frequency superposition on the driving signal.

The optical recording medium driving apparatus further includes a light receiving unit configured to receive an optical feedback of a laser beam, which has been emitted by the laser beam source, from an optical recording medium.

The optical recording medium driving apparatus further includes an evaluation signal generating unit configured to generate an evaluation signal based on a light reception signal from the light receiving unit, in which the evaluation signal is used as an evaluation indicator for signal quality, and an accuracy of measurement of a value of the evaluation signal is likely to become poor with increase in scoop ratio.

The optical recording medium driving apparatus further includes a storage unit configured to store, as high frequency superposition amount information for instructing a high frequency superposition amount to be implemented by the high frequency superposition unit, first high frequency superposition amount information corresponding to a high frequency superposition amount to be set for a normal reproduction mode and second high frequency superposition amount information corresponding to a high frequency superposition amount that is greater than that represented by the first high frequency superposition amount information.

The optical recording medium driving apparatus further includes a superposition amount control unit configured to perform control so that a high frequency superposition amount corresponding to the second high frequency superposition amount information is set to the high frequency superposition unit in response to when measuring an evaluation index based on the above evaluation signal.

As described above, according to the present embodiment, a superposition amount greater than that is set for a normal reproduction mode is set to the high frequency superposition unit in response to when measuring an evaluation index, an accuracy of measurement of which is likely to become poor with increase in scoop ratio. This allows the signal quality evaluation index such as a β value and a modulation factor to be measured more accurately.

Since a regulation value for unnecessary radiation noise is a time averaged value, even if a superposition amount is increased only for a temporary period for evaluation index measurement as recited above, compliance with applicable standards, rules, and conventions is possible.

Thus, the present technology allows an evaluation index such as a β value and a modulation factor, an accuracy of measurement of which deteriorates with increase in scoop ratio, to be more accurately measured, while complying with applicable standards, rules, and conventions regarding unnecessary radiation noise.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 illustrates an inner structure of an optical recording medium driving apparatus according to a first embodiment of the present technology;

FIG. 2 illustrates a structure of a section associated with laser emission;

FIG. 3 is a flowchart illustrating a specific processing sequence to be performed to realize a high frequency superposition technique (increasing a high frequency superposition amount when measuring an evaluation index) according to the first embodiment;

FIG. 4 is a flowchart illustrating a specific processing sequence to be performed to realize a high frequency superposition technique (increasing a high frequency superposition amount when data read is retried) according to the first embodiment;

FIG. 5 illustrates an inner structure of an optical recording medium driving apparatus according to a second embodiment of the present technology;

FIG. 6 illustrates a relationship between a superposition amount instruction value and a laser driving voltage;

FIG. 7 is a diagram for illustrating a high frequency superposition technique according to the second embodiment;

FIG. 8 is a flowchart illustrating a specific processing sequence to be performed to realize the high frequency superposition technique according to the second embodiment; and

FIG. 9 is a diagram for illustrating another example for realizing the high frequency superposition technique according to the second embodiment.

### DETAILED DESCRIPTION OF EMBODIMENTS

Hereinafter, embodiments of the present technology will be described in the sequence below.

1. First Embodiment
1-1. Exemplary Structure of Optical Recording Medium Driving Apparatus
1-2. High Frequency Superposition Technique According to First Embodiment
1-3. Processing Sequence

2. Second Embodiment

3. Modified Examples

### 1. First Embodiment

### 1-1. Exemplary Structure of Optical Recording Medium Driving Apparatus

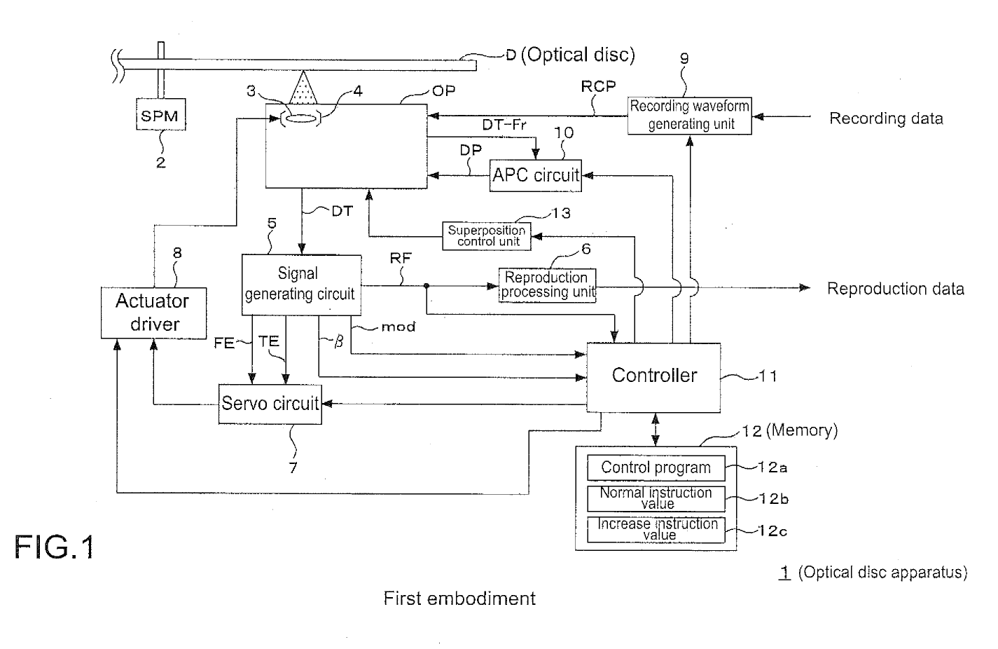

FIG. 1 illustrates an inner structure of an optical recording medium driving apparatus (hereinafter referred to as “optical disc apparatus 1”) as a first embodiment of the present technology.

First, an optical disc D in the drawing is a disk-shaped optical recording medium (optical disc recording medium). As used herein, the term “optical recording medium” indicates a recording medium on which at least one of recording and reproduction of information is performed by light irradiation.

When loaded into the optical disc apparatus 1, the optical disc D is rotationally driven by a spindle motor (SPM) illustrated in the drawing according to a predetermined rotation control mode such as a constant linear velocity (CLV) mode, with a center hole thereof being clamped.

The optical disc apparatus 1 is provided with an optical pickup OP which irradiates a leaser beam onto the rotating optical disc D for recording and reproducing information, and which receives reflected light (optical feedback) of the laser beam irradiated onto the optical disc D.

A semiconductor laser (a laser diode 20 to be described later) which is a beam source of the aforementioned laser beam is disposed within the optical pickup OP.

Furthermore, an objective lens 3 for condensing the aforementioned laser beam on the optical disc D and a triaxial actuator 4 are disposed within the optical pickup OP. The triaxial actuator 4 is provided for tilting the objective lens 3 with respect to the optical axis thereof while holding the objective lens 3 in a manner movable towards and away from the optical disc D (i. e., in a focusing direction) and movable in a radial direction (i.e., in a tracking direction).

In addition, a light receiving unit, having a photodetector for receiving light reflected from the optical disc D via the objective lens 3, is disposed within the optical pickup OP.

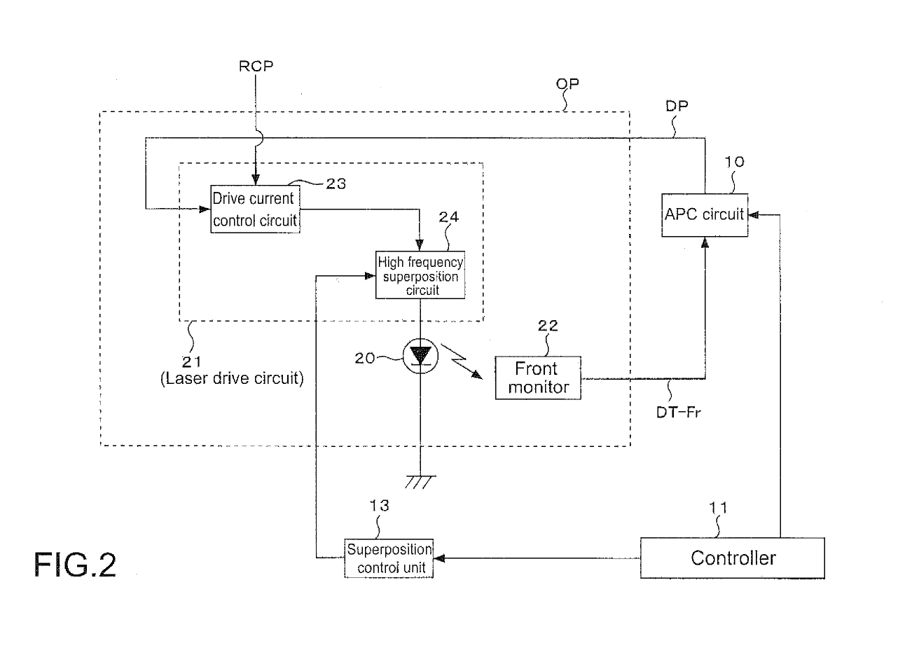

Within the optical pickup OP, a driving circuit (a laser driving circuit 21 to be described later) for driving the laser diode 20 for emission, and a front monitor (a front monitor 22 to be described later) for obtaining a light reception signal DT-Fr that is used for automatic power control (APC) processing by an APC circuit 10 illustrated in the drawing, are also disposed. These components will be described later in connection with FIG. 2.

The light reception signal from the aforementioned light receiving unit in the optical pickup OP (hereinafter referred to as “light reception signal DT”) is fed to a signal generating circuit 5.

The signal generating circuit 5 uses a predetermined arithmetic processing to generate a necessary signal based on the light reception signal DT.

The signal generating circuit 5 generates, for example, a high frequency signal used for obtaining reproduction data (i.e., reproduction data signal, hereinafter termed as “RF signal”), a focus error signal FE for servo control, and a tracking error signal TE. As used herein, the focus error signal FE is a signal representing a focusing position error of a laser beam with respect to a recording surface (reflecting surface) formed on the optical disc D. The tracking error signal TE is a signal representing a position error in an along-track direction of an irradiation spot of the aforementioned laser beam with respect to a track formed on the aforementioned recording surface.

The signal generating circuit 5 also generates evaluation indexes (evaluation signals) such as a β value and a modulation factor mod, given by:

β=(A+B)/(A−B), and

mod=(A′−B′)/A′,

where A and B are respectively a top peak value and a bottom peak value of the RF signal after AC coupling (after DC cutting), and A′ and B′ are respectively a top peak value and a bottom peak value of the RF signal before AC coupling.

An RF signal generated by the signal generating circuit 5 is supplied to a reproduction processing unit 6. The reproduction processing unit 6 performs reproduction processing (data read processing) such as binarization processing and error correction processing on the RF signal, thereby obtaining reproduction data.

The RF signal is also supplied to a controller 11, where the amplitude value thereof is used as an evaluation index, for example, when focus bias (FB) adjustment is performed.

The focus error signal FE and the tracking error signal TE, both generated by the signal generating circuit 5, are supplied to a servo circuit 7.

The servo circuit 7 realizes focus servo control and tracking servo control respectively based on the focus error signal FE and the tracking error signal TE.

Specifically, the servo circuit 7 generates a focus servo signal and a tracking servo signal respectively based on the focus error signal FE and the tracking error signal TE, and provides the focus servo signal and the tracking servo signal to an actuator driver 8.

The actuator driver 8 generates a focus driving signal and a tracking driving signal respectively based on the focus servo signal and the tracking servo signal, and drives a focus coil and a tracking coil of the triaxial actuator 4 respectively by the focus driving signal and the tracking driving signal. In this way, a focus servo loop and a tracking servo loop are formed, each of which are composed of the triaxial actuator 4, the signal generating circuit 5, the servo circuit 7, and the actuator driver 8, which are connected in a closed loop.

The actuator driver 8 adjusts a tilt degree of the objective lens 3 formed by the triaxial actuator 4 according to an instruction from the controller 11.

The optical disc apparatus 1 further includes a recording waveform generating unit 9 and an APC circuit 10.

Recording data to be recorded on the optical disc D is input to the recording waveform generating unit 9. The recording waveform generating unit 9 generates a recording waveform signal RCP corresponding to the aforementioned recording data based on parameters relative to a pulse width, a pulse height, etc., which are determined through write strategy adjustment processing, optimum power control (OPC) processing, etc., and provides the recording waveform signal RCP to the laser driving circuit 21 (driving current control circuit 23 to be described later) within the optical pickup OP. As a result, signal recording corresponding to the recording data above is performed on the optical disc D.

The APC circuit 10 performs APC processing so that the power of emission by the laser diode 20 is held constant at a target power designated by the controller 11 based on the light reception signal DT-Fr from the aforementioned front monitor 22.

FIG. 2 illustrates a structure of a section of the optical disc apparatus 1 associated with laser emission (mainly, a structure of a part within the optical pickup OP associated with laser emission).

As shown, the laser diode 20, the laser driving circuit 21, and the front monitor 22 are provided in the optical pickup OP as components associated with laser emission.

FIG. 2 also illustrates the APC circuit 10, the controller 11, and a superposition control unit 13, which are illustrated in FIG. 1.

The laser driving circuit 21 includes a driving current control circuit 23 and a high frequency superposition circuit 24.

Based on a driving signal DP (driving voltage) from the APC circuit 10 and a recording waveform signal RCP when it is during recording, the driving current control circuit 23 generates a laser driving current for driving the laser diode 20 for emission. The laser driving current is supplied to the laser diode 20 via the high frequency superposition circuit 24.

The high frequency superposition circuit 24 superposes a high frequency current on the aforementioned laser driving current. Superposing a high frequency current is performed for reducing optical feedback noise.

The high frequency superposition circuit 24 in this case is configured so that it can change an amount of high frequency current to be superposed on the aforementioned laser driving current, according to an instruction from the superposition control unit 13. The superposition control unit 13 provides a superposition amount instruction signal at a level corresponding to an instruction value from the controller 11 to the high frequency superposition circuit 24, thereby controlling an amount of high frequency current to be superposed.

Returning to FIG. 1, the controller 11 is composed of a microcomputer including, for example, a central processing unit (CPU), a read only memory (ROM), and a random access memory (RAM), and controls overall operation of the optical disc apparatus 1 by performing processing according to a program, for example, stored in the aforementioned ROM, etc.

By way of example, the controller 11 determines an optimum recording power by performing OPC processing based on an evaluation index such as a β value and a modulation factor mod. The information about the optimum recording power obtained by the OPC processing is provided to the recording waveform generating unit 9.

Furthermore, the controller 11 performs FB adjustment processing based on an amplitude value of an RF signal, thereby determining an FB value regarded to be optimum. The optimum FB value thus determined by the FB adjustment processing is designated to the servo circuit 7.

Furthermore, the controller 11 also performs tilt adjustment processing based on an amplitude value of an RF signal, thereby determining an optimum tilt control value. The optimum tilt control value thus determined is designated to the actuator drive 8.

The controller 11 also designates a target laser power to the APC circuit 10.

Furthermore, the controller 11 instructs the superposition control unit 13, thereby controlling an amount of high frequency superposition to be performed by the high frequency superposition circuit 24.

In addition, a memory 12 (non-volatile memory) is provided in the controller 11.

As shown, a control program 12a, a normal-superposition instruction value 12b, and an increased-superposition instruction value 12c (hereinafter referred to as “normal instruction value 12b” and “increase instruction value”) are stored in the memory.

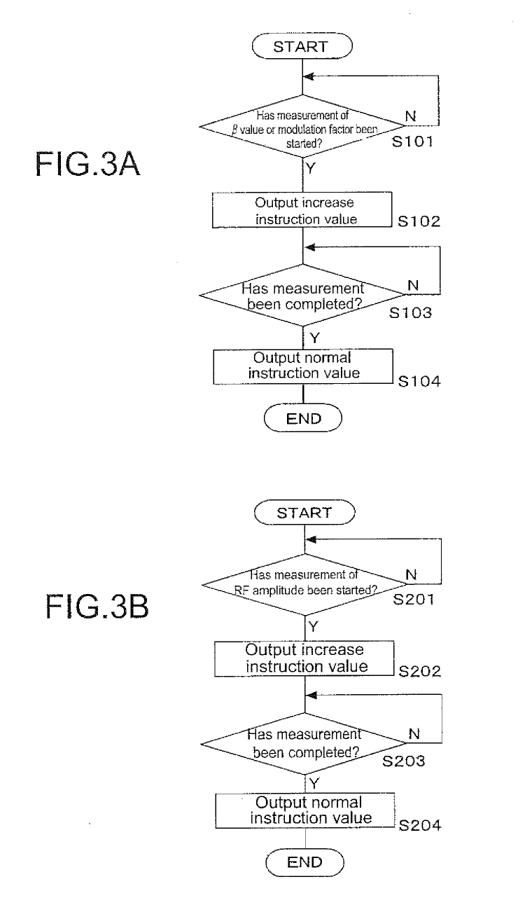

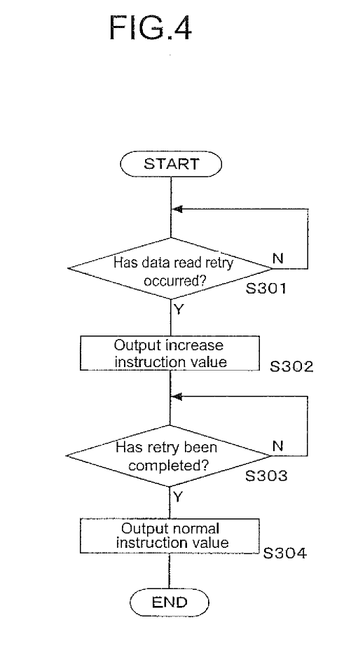

The control program 12a is a program to allow the controller 11 to perform processing operations illustrated in FIGS. 3 and 4.

The normal instruction value 12b and the increase instruction value 12c will be described later.

As can be understood from the foregoing description, the optical disc apparatus 1 according to the present embodiment is configured to allow the controller 11 to variably set a high frequency superposition amount to the high frequency superposition circuit 24.

Some of conventional optical disc apparatuses set a fixed value that has merely been experimentally determined as a high frequency superposition amount. However, when a high frequency superposition amount is a fixed value, it may cause a situation that unnecessary radiation noise associated with high frequency superposition does not fall within a regulation value depending on a housing (for example, a personal computer) for accommodating an optical disc apparatus. For this reason, there has been a case that some high-cost measure, such as enhancing grounding (GND) property and adding a radio wave absorbing sheet had to be taken.

In contrast, according to the structure that a high frequency superposition amount is allowed to be adjusted as described above, a high frequency superposition amount can be adjusted for each product, so that necessity of taking a high-cost measure as described above can be avoided.

### 1-2. High Frequency Superposition Technique According to First Embodiment

As described above, if a high frequency superposition amount is too low, the problems arise that data reproducibility deteriorates, and that a scoop ratio (which is the ratio between a reflected light amount from a part in which a mark or a pit is formed, and a reflected light amount from a land part) increases so that it becomes difficult to accurately measure signal quality evaluation indexes such as a β value and a modulation factor.

On the other hand, if the high frequency superposition amount is set to be large, there arises a problem that unnecessary radiation noise increases.

In view of the above, according to the present embodiment, a high frequency superposition amount to be implemented by the high frequency superposition circuit 24 is allowed to be variably set, and furthermore a superposition amount that is greater than that for normal reproduction is set when a signal quality evaluation index such as a β value and a modification factor mod is measured, so that the evaluation index is allowed to be accurately measured while complying with applicable standards, rules, and conventions regarding unnecessary radiation noise.

According to the present embodiment, information for designating a high frequency superposition amount to be set in response to when performing normal reproduction, and information for designating a high frequency superposition amount to be set when performing measurement of an evaluation index mentioned above, are determined experimentally in advance and prestored in each optical disc apparatus 1. Specifically, the prestored information are the normal instruction value 12b and the increase instruction value 12c illustrated in FIG. 1.

To determine the normal instruction value 12b and the increase instruction value 12c, it is necessary to account for variations among individual optical disc apparatuses 1 (optical pickups OP). This is because if these instruction values are decided without allowing for such variations, some optical disc apparatuses may suffer from the problem that unnecessary radiation noise cannot be suppressed to a sufficiently low value, etc.

In consideration of this point, with regard to the normal instruction value 12b and the increase instruction value 12c mentioned above, values most effective for accommodating variations among individual products are determined in advance, for example, by experiment and simulation, by determining values corresponding to the properties of a middle product (i.e., a product having intermediate properties from the view point of specification) used as a reference optical disc 1 (hereinafter referred to as “reference product”). These values thus determined are stored in each optical disc apparatus 1.

At this time, the normal instruction value 12b may be determined so that an unnecessary radiation noise level associated with a high frequency superposition amount that is set based thereon is sufficiently low with respect to a regulation value, as the sake of guidance.

The increase instruction value 12c may be determined so that a high frequency superposition amount, which is greater than the high frequency superposition amount set based on the normal instruction value 12b, can be obtained.

For record, since a regulation value for unnecessary radiation noise is a time averaged value, even if a superposition amount is increased only during a temporary period as an evaluation index measurement period, compliance with applicable standards, rules, and conventions regarding unnecessary radiation noise is possible.

In other words, the increase instruction value 12c can be determined under the condition that the unnecessary radiation noise level thereof falls within a regulation value.

Note that the regulation value for unnecessary radiation noise is a measurement value based on an electrical charge time constant of a quasi-peak (QP) detector, an electrical discharge time constant of a QP detector, and a time constant of a QP indicator, based on a QP measuring standard. Thus, reducing a superposition period as well as adjusting a superposition amount is effective for an unnecessary radiation noise level to be contained within a regulation value.

Evaluation indexes, an accuracy of measurement of which is adversely affected with decrease in high frequency superposition amount, i.e., with increase in scoop ratio, include an RF signal amplitude value as well as a β value and a modulation factor mod.

Thus, according to the present embodiment, it is also performed to temporarily increase a high frequency superposition amount when an RF signal amplitude value is measured, for example, during FD adjustment processing and tilt adjustment processing.

However, when allowance for unnecessary radiation noise is made, data reproducibility is sacrificed correspondingly. Taking into account this point, according to the present embodiment, also when a data reproduction (data read) retry state occurs, a high frequency superposition amount is temporarily increased by switching from the normal instruction value 12b to the increase instruction value 12c.

This can enhance reproducibility when retried, and in turn can improve a retry success rate.

### 1-3. Processing Sequence

FIG. 3 and FIG. 4 are flowcharts illustrating a specific processing sequence to be performed to realize the high frequency superposition technique according to the first embodiment described above.

Referring to FIG. 3, FIG. 3A illustrates a processing sequence to be performed when a β value or a modification factor mod is measured, and FIG. 3B illustrates a processing sequence to be performed in response to when measuring an RF signal amplitude.

FIG. 4 illustrates a processing sequence to be preformed in response to when retrying data read.

The processing steps in FIGS. 3 and 4 are performed by the controller 11 illustrated in FIG. 1 according to the control program 12a.

Referring to FIG. 3A, first, in step S101, the controller 11 waits until it becomes necessary to measure a β value or a modulation factor mod. That is, the controller 11 waits until it becomes necessary to start measurement of a β value or modulation factor mod, for example, as measurement of an evaluation index during OPC processing.

When it becomes necessary to start measurement of a β value or a modulation factor mod, the controller 11 outputs the increase instruction value 12c in step S102. In other words, outputting the increase instruction value 12c to the superposition control unit 13 allows the high frequency superposition circuit 24 to perform high frequency superposition of a superposition amount corresponding to the increase instruction value 12c.

This increases a high frequency superposition amount implemented by the high frequency superposition circuit 24 from a superposition amount corresponding to the normal instruction value 12b.

In subsequent step S103, the controller 11 waits until the measurement of a β value or modulation factor mod completes. When the measurement completes, the controller 11 outputs the normal instruction value 12b in step S104. In Other words, a high frequency superposition amount to be implemented by the high frequency superposition circuit 24 is switched back to the superposition amount corresponding to a normal reproduction mode.

After the processing of step S104 is performed, the controller 11 exits the processing sequence illustrated in this drawing.

Referring to FIG. 3B, in step S201, the controller 11 waits until it becomes necessary to start measurement of an RF signal amplitude. In other words, the controller 11 waits until it becomes necessary to start measurement of an RF signal amplitude as measurement of an evaluation index, for example, during FB adjustment processing or during tilt adjustment processing.

Since steps S202 to S204 subsequent thereto are substantially the same as steps S102 to S104 except that the β value or the modulation factor mod is replaced with the RF signal amplitude value, descriptions thereof are omitted.

Regarding the processing in FIG. 4, first, the controller 11 waits until retry of data read occurs in step S301.

In response to occurrence of the data read retry state, the controller 11 outputs the increase instruction value 12c in step S302.

After the increase instruction value 12c is output, the controller 11 waits until the retry completes in step S303 and outputs the normal instruction value 12b in step S304 according to the retry completion.

After the processing of step S304 is performed, the controller 11 exits the processing sequence illustrated in this drawing.

As described above, according to the present embodiment, a superposition amount greater than that is set for the normal reproduction mode is set to the high frequency superposition circuit 24 in response to when measuring an evaluation index such as a β value, a modulation factor mod, and an RF signal amplitude value, an accuracy of measurement of which deteriorates with increase in scoop ratio.

This allows the aforementioned evaluation index to be measured more accurately, while complying with applicable standards, rules, and conventions regarding unnecessary radiation noise.

Furthermore, according to the present embodiment, the superposition amount is temporarily increased also when data read is retried. This can improve a retry success rate.

In other words, this means that setting to decrease a superposition amount for the normal reproduction mode can be easily implemented. If setting to lower a superposition amount for the normal reproduction mode is facilitated as recited above, an unnecessary radiation noise level can be suppressed correspondingly. Also in view of this, necessity of taking a high-cost measure as mentioned above such as addition of a radio wave absorbing sheet, can be eliminated.

### 2. Second Embodiment

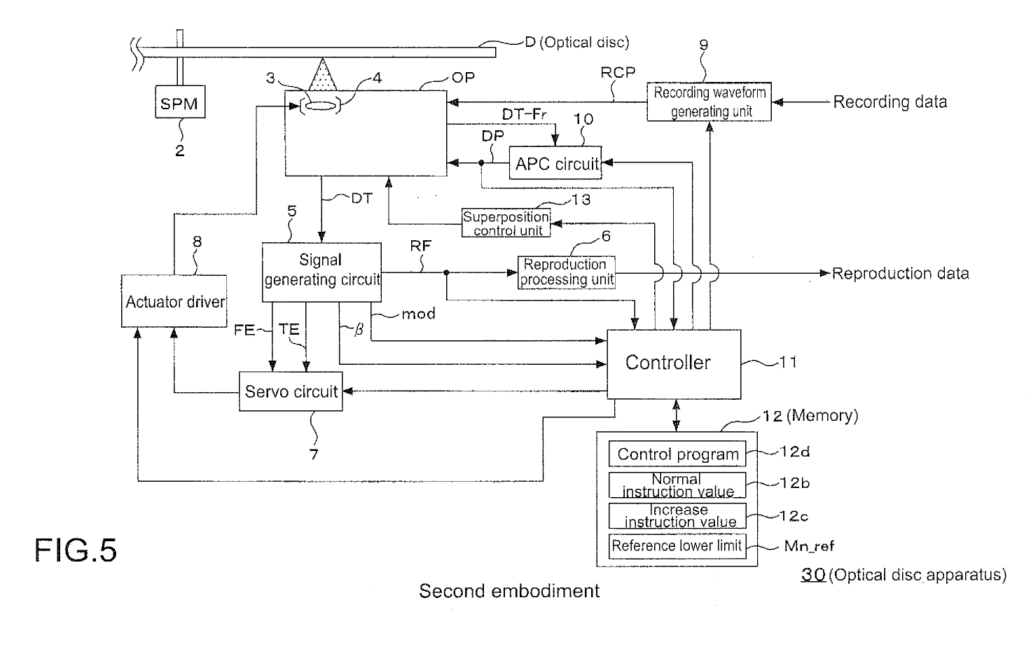

In the following, a second embodiment will be described. FIG. 5 illustrates an inner structure of an optical recording medium driving apparatus (hereinafter referred to as “optical disc apparatus 30”) according to a second embodiment of the present technology.

Parts illustrated in FIG. 5 which are similar to those already described are denoted by the same symbols with no further description.

As is apparent from comparison with FIG. 1 previously described, compared with the optical disc apparatus according to the first embodiment, the optical disc apparatus 30 according to the second embodiment is different therefrom in that a driving signal DP (driving voltage) from the APC circuit 10 is also input to the controller 11, a control program 12d is stored in the memory 12 in place of the control program 12a, and a reference lower limit Mn_ref is newly stored in the memory 12.

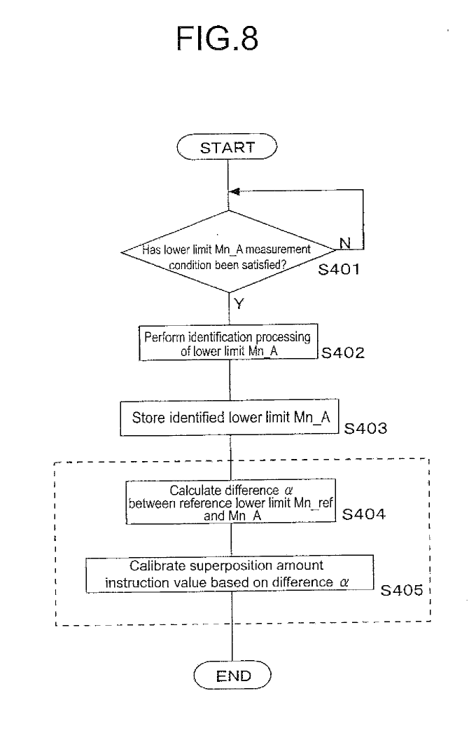

The control program 12d is a program to allow the controller 11 to perform processing operations illustrated in FIG. 8 subsequent thereto.

The reference lower limit Mn_ref will be described below.

A relationship between an instruction value relating to a high frequency superposition amount from the controller 11 and an amount of high frequency current superposition actually applied to a laser driving current may vary among individual products.

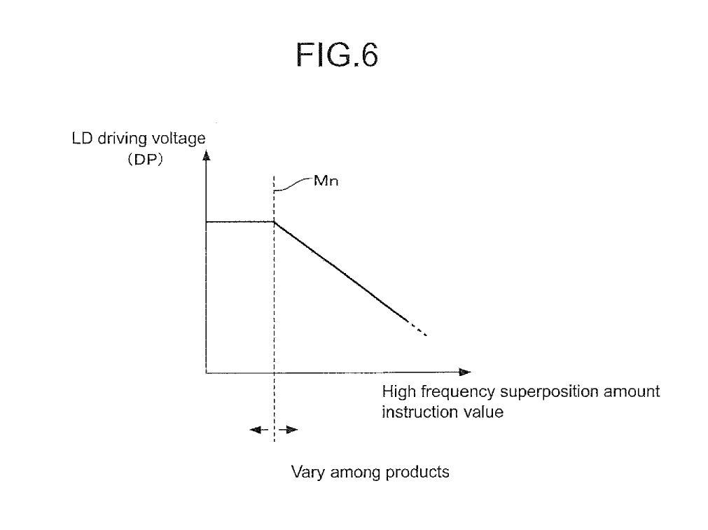

FIG. 6 illustrates a relationship between a high frequency superposition amount instruction value and an LD driving voltage (a driving signal DP). The relationship illustrated in the drawing is based on the premise that the APC processing has been performed.

As shown in FIG. 6, as the high frequency superposition amount instruction value is decreased, the LD driving voltage tends to gradually increase. As the high frequency superposition amount instruction value decreases to a certain value, rise of the LD driving voltage stops, and the voltage turns to remain constant.

A high frequency superposition amount instruction value at which a level of LD driving voltage turns to remain constant as the high frequency superposition amount instruction value is reduced is termed as “superposition amount lower limit Mn” (or is simply termed as “lower limit Mn”).

Variations in this superposition amount lower limit Mn among products (i.e., among ICs used as the laser driving circuits 21) lead to variations in the relationship between a superposition amount instruction value with respect to a high frequency superposition circuit 24 and an actual high frequency superposition amount.

Furthermore, even within the same product, such variations can be caused due to change with temperature, change with time, etc.

The second embodiment proposes a technique to accommodate such variations in the superposition amount lower limit Mn (i.e., variations in the relationship between a superposition amount instruction value and an actual superposition amount).

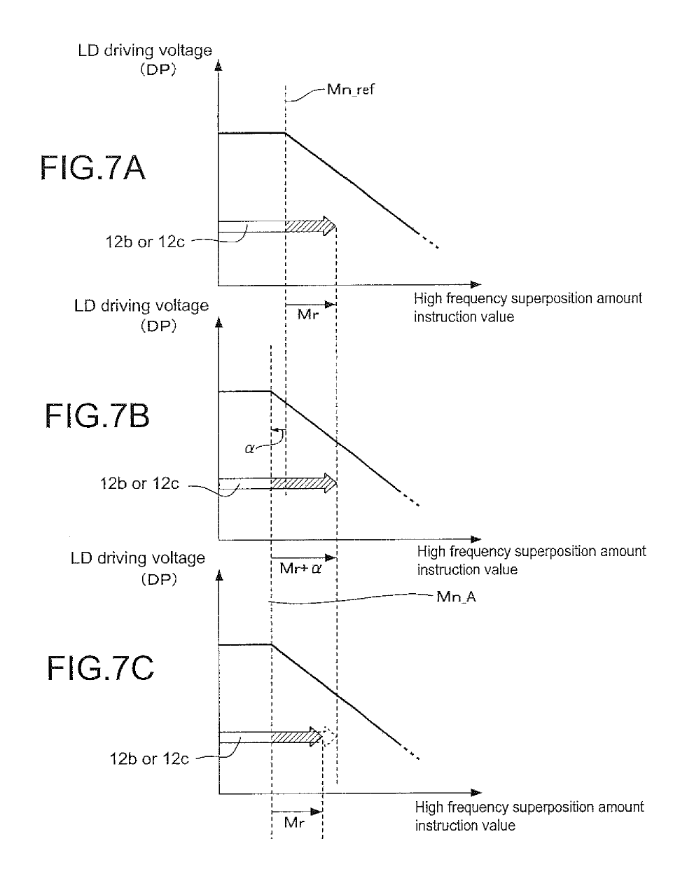

FIG. 7 is a diagram for illustrating a high frequency superposition technique according to the second embodiment.

First, the relationship between the lower limit Mn and both the normal instruction value 12b and the increase instruction value 12c will be described in connection with FIG. 7A.

With regard to the normal instruction value 12b and the increase instruction value 12c, as can be understood from the previous description of the first embodiment, specific values thereof are defined so as to satisfy the aforementioned condition based on the properties of a reference product such as a middle product, whereby it is ensured that the most of variations among products can be accommodated.

As a matter of fact, however, the lower limit Mn varies among products. Thus, if fixed values are used as the normal instruction value 12b and the increase instruction value 12c, it may cause a situation that an actual superposition amount of one product is small, whereas that of another product is large.

In FIG. 7A, a lower limit Mn of a reference product such as a middle product (termed as “reference lower limit Mn_ref”) is illustrated, by way of example.

As described above, the normal instruction value 12b and the increase instruction value 12c are defined based on the properties of a reference product. At this time, an actual high frequency superposition amount value can be represented as a shaded area in the drawing. The actual superposition amount is denoted by superposition amount Mr as in the drawing.

If this superposition amount Mr is set for each product, then variations among products would be accommodated.

FIG. 7B illustrates a relationship between a lower limit Mn and both the normal instruction value 12b and the increase instruction value 12c, of an actual product that is different from the reference product, bay way of example.

In this product, the lower limit Mn is a value that is lower than the reference lower limit Mn_ref of the reference product by. In this description, such a lower limit Mn of an actual product is termed as “lower limit Mn_A” as in the drawing.

Using a preset normal instruction value 12b and a preset increase instruction value 12c as they are for the product illustrated in FIG. 7B causes a situation that an actual high frequency superposition amount (a shaded area) thereof is greater than a proper superposition amount Mofs by an amount corresponding to indicated in the drawing.

Thus, the normal instruction value 12b and the increase instruction value 12c are calibrated based on above as illustrated in FIG. 7C, so that a proper superposition amount Mr can be obtained.

Specifically, the aforementioned is a difference between an actually measured lower limit Mn and the reference product's lower limit Mn_ref.

As previously described in connection with FIG. 5, for the optical disc apparatus 30 of the second embodiment, the reference lower limit Mn_ref is previously stored in the memory 12.

For calibration, first, the lower limit Mn is actually measured. Then, the difference α between this lower limit Mn and the reference lower limit Mn_ref is calculated. Subsequently, based on this difference α, the normal instruction value 12b and the increase instruction value 12c are calibrated. Specifically, the “normal instruction value 12b−α” and the “increase instruction value 12c−α” are calculated.

According to the second embodiment, the normal instruction value 12b and the increase instruction value 12c, which are calibrated based on the difference α between the reference lower limit Mn_ref and the actually measured lower limit Mn, are respectively output (designated) to the superposition control unit 13 in a timely manner according to steps S102, S104; S202, S204; and S302, S304.

This allows variations among products and variations due to change with temperature, change with time, etc. to be properly accommodated.

If only variations among products are taken into account, it is only necessary to calibrate the normal instruction value 12b and the increase instruction value 12c at least when the optical disc apparatus 30 is driven for the first time.

When variations due to change with temperature and change with time are also accommodated as well as variations among products, it is effective to calibrate the normal instruction value 12b and the increase instruction value 12c, for example, each time the optical disc D is loaded, at regular time intervals, or each time predetermined temperature variations occur.

FIG. 8 is a flowchart illustrating a specific processing sequence to be performed to realize the high frequency superposition technique according to the second embodiment described above.

The processing steps in FIG. 8 are performed by the controller 11 illustrated in FIG. 5 according to the control program 12d.

Referring to FIG. 8, the controller 11 waits until a condition for measuring a lower limit Mn_A is satisfied in step S401. Specifically, the controller 11 waits until a predetermined condition for measuring a lower limit Mn_A, for example, “the optical disc apparatus is driven for the first time”, “the optical disc D is loaded”, “a predetermined time has elapsed”, “a temperature variation more than a predetermined one occurs”, etc., is satisfied.

The controller 11 performs processing for identifying a lower limit Mn_A as the condition for measuring a lower limit Mn_A is satisfied. Specifically, the controller 11 gradually lowers the instruction value to be output to the superposition control unit 13 while monitoring the level of a driving signal DP in a state in which APC is performed by the APC circuit 10, and identifies an instruction value at which a level of the driving signal DP turns to remain constant.

After the identification processing in step S402 is performed, the controller 11 performs processing to store the lower limit Mn_A identified by the identification processing in step S403. The lower limit Mn_A thus identified is stored in a desired storage means, for example, in the memory 12.

In subsequent step S404, the controller 11 calculates a difference α between the reference lower limit Mn ref and the lower limit Mn_A.

Then, in step S405, the controller 11 calibrates the superposition amount instruction value based on the difference α. Specifically, the normal instruction value 12b and the increase instruction value 12c are respectively calibrated by calculating “the normal instruction value 12b −α” and “the increase instruction value 12c−α”.

After the processing of step S404 is performed, the controller 11 exits the processing sequence illustrated in this drawing.

The calibration processing of steps S404 and S405, enclosed by the broken line in the drawing, does not have to be performed subsequent to the measurement of the lower limit Mn as described above. It only needs to be performed at least before the superposition amount instruction value (the normal instruction value 12b or the increase instruction value 12c) is set.

According to the high frequency superposition technique of the second embodiment as described above, it is allowed to perform calibration of a superposition amount instruction value corresponding to the properties inherent to each optical disc apparatus 30, so that precise and accurate control can be realized compared with the first embodiment.

Thus, a margin for noise to be allowed for with respect to that defined by applicable standards, rules, and conventions regarding unnecessary radiation noise, may be less than that provided in the first embodiment. Thus, the data reproducibility and the accuracy of measurement of an evaluation index can be correspondingly enhanced.

Alternatively, if a margin for suppression of unnecessary radiation noise is provided in place thereof, unnecessary radiation noise can be reduced more than in the first embodiment.

Furthermore, according to the second embodiment, variations due to change with temperature and change with time can also be accommodated.

However, a technique to accommodate variations by means of actually measuring a lower limit Mn_A is not limited to the technique described above.

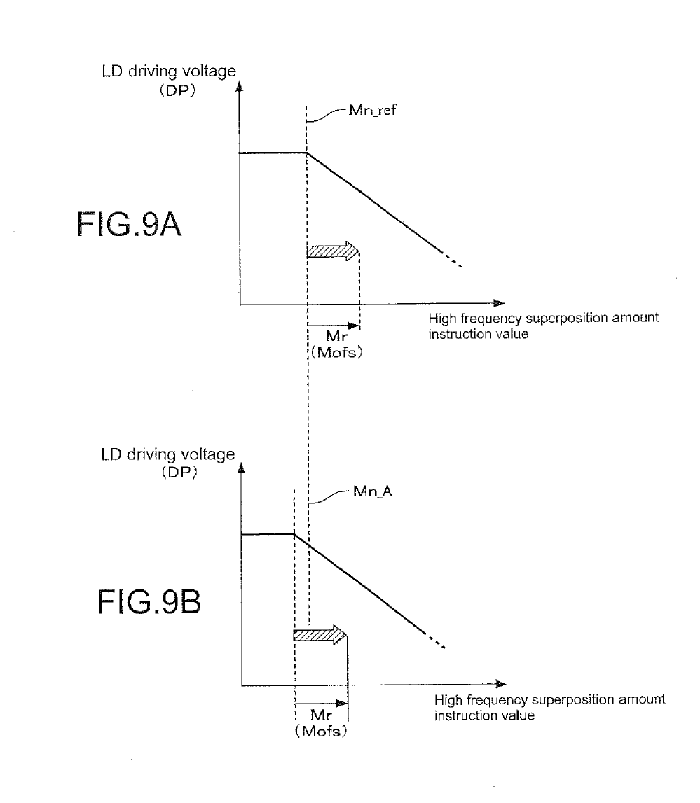

FIG. 9 is a diagram for illustrating another example for realizing the high frequency superposition technique according to the second embodiment.

FIG. 9A illustrates a reference lower limit Mn_ref of a reference product such as a middle product, by way of example, similar to FIG. 7A. FIG. 9B illustrates a lower limit Mn_A of a product in which a variation has occurred, similar to FIG. 7B.

As can be seen from FIG. 7 previously described, a factor causing variations in the actual superposition amount is that a lower limit Mn varies due to properties specific to each product, change with temperature, and change with time.

In view of the above, if a superposition amount Mr (i.e., an offset to the reference lower limit Mn_ref) is added to a lower limit Mn_A obtained by measuring an actual product, a result similar to that of the technique described in connection with FIG. 7 can be obtained.

Specifically, according to this technique, superposition amount instruction values equivalent to the superposition amount Mr determined by experiments, etc., based on properties of a reference product are prestored in each optical disc apparatus 30 as offset values Mofs. More particularly, an offset value Mofs from the normal instruction value 12b (represented as Mofs-1) and an offset value Mofs from the increase instruction value 12c (represented as Mofs-2) are prestored.

The optical disc apparatus 30 in this case performs measurement of a lower limit Mn_A in response to satisfaction of the measurement condition, and stores the lower limit Mn_A, for example, in the memory 12, etc.

Then, when it becomes necessary to set the normal instruction value 12b or the increase instruction value 12c in actuality, a superposition amount instruction value, which is determined by adding the aforementioned offset value Mofs to the prestored lower limit Mn_A, is designated to the high frequency superposition circuit 24 via the DAC 13. Specifically, when it becomes necessary to set the normal instruction value 12b, a superposition amount instruction value determined by adding the offset value Mofs-1 to the lower limit Mn_A is designated, while, when it becomes necessary to set the increase instruction value 12c, a superposition amount instruction value determined by adding the offset value Mofs-2 to the lower limit Mn_A is designated.

This allows variations among products, variations due to change with temperature, and variations due to change with time to be accommodated as with the technique described in connection with FIG. 7.

The above description is given upon the case in which “the lower limit Mn_A+the offset value Mofs” is calculated in response to the fact that it has become necessary to actually set the superposition amount instruction value. However, it is also allowable that the “the lower limit Mn_A+the offset value Mofs” is calculated subsequent to measurement of a lower limit Mn_A, and the value thus determined is stored in the memory 12, etc.

### 3. Modified Examples

While embodiments of the present technology have been described above, the present technology is not to be limited to the foregoing specific examples.

For example, comparing pigment-based disks having a high reflectivity with phase change disks having a low reflectivity, it is thought that high frequency superposition amount instruction values regarded as optimum for the pigment-based disks are different from those for phase change disks.

In view of this, it is also possible to store in advance the normal instruction value 12b and the increase instruction value 12c (or offset value Mofs) for each of the disk types having different reflectivities, and designate the normal instruction value 12b and the increase instruction value 12c (or lower limit Mn_A+Mofs) corresponding to the disk type of the loaded optical disc D.

In the foregoing description, a high frequency superposition amount according to the same increase instruction value 12c is set both when measuring a signal evaluation index such as a β value and a modulation factor mod and when retrying data read. However, there may be a case in which a high frequency superposition amount which optimizes the accuracy of measurement of a signal evaluation index such as a β value and a modulation factor mod is different from a high frequency superposition amount which optimizes the data reproducibility. In such a case, performing high frequency superposition according to the common increase instruction value 12c may sacrifice an accuracy of evaluation index measurement or the reproducibility during retrying.

In view of this, it is also possible that an increase instruction value to be set when measuring an evaluation index (referred to as “first increase instruction value”) and an increase instruction value to be set when retying data read are separately determined and presorted in the memory 12, etc., so that a high frequency superposition amount corresponding to the first increase instruction value is set in response to when measuring an evaluation index, and a high frequency superposition amount corresponding to the second increase instruction value is set in response to when retrying data read.

This technique can be also preferably applied when the offset value Mofs as shown in FIG. 9 is used.

In the foregoing, description has been made on the case of applying the present technology to an optical recording medium driving apparatus for which recording to and reproduction from an optical recording medium is allowed, by way of example. However, the present technology can be also preferably applied to an optical recording medium driving apparatus configured to perform at least reproduction from an optical recording medium.

The present technology may also take configurations as recited below.

(1) An optical recording medium driving apparatus, including:

a driving signal generating unit configured to generate a driving signal for driving a laser beam source for emission;

a high frequency superposition unit configured to perform high frequency superposition on the driving signal;

a light receiving unit configured to receive an optical feedback of a laser beam, which has been emitted by the laser beam source, from an optical recording medium;

an evaluation signal generating unit configured to generate an evaluation signal based on a light reception signal from the light receiving unit, the evaluation signal being used as an evaluation indicator for signal quality, an accuracy of measurement of the evaluation signal being likely to become poor with increase in scoop ratio;

a storage unit configured to store, as high frequency superposition amount information for instructing a high frequency superposition amount to be implemented by the high frequency superposition unit, first high frequency superposition amount information corresponding to a high frequency superposition amount to be set for a normal reproduction mode and second high frequency superposition amount information corresponding to a high frequency superposition amount that is greater than that represented by the first high frequency superposition amount information; and

a superposition amount control unit configured to perform control so that a high frequency superposition amount based on the second high frequency superposition amount information is set to the high frequency superposition unit in response to when measuring an evaluation index based on the evaluation signal.

(2) The optical recording medium driving apparatus according to (1) above,

further including a reproduction unit configured to reproduce recorded information on the optical recording medium based on the light reception signal,

in which the superposition amount control unit performs control so that a high frequency superposition amount that is greater than the high frequency superposition amount to be set for the normal reproduction mode is set to the high frequency superposition unit in response to when the reproduction unit retries information reproduction.

(3) The optical recording optical recording medium driving apparatus according to (1) or (2) above,

further including an automatic power control (APC) unit configured to adjust a level of the driving signal so that emission power of the laser beam is held constant,

in which the superposition amount control unit identifies a lower superposition amount instruction value as a high frequency superposition amount instruction value at which the level of the driving signal turns to remain constant as the high frequency superposition amount instruction value of the high frequency superposition unit is lowered, and designates a high frequency superposition amount instruction value, that has been calculated based on the identified lower superposition amount instruction value and one of the first high frequency superposition amount information and the second high frequency superposition amount information, to the high frequency superposition unit.

(4) The optical recording medium driving apparatus according to (3) above, in which

the first high frequency superposition amount information and the second high frequency superposition amount information are information that are set as an offset value from the identified lower superposition amount instruction value, and

the superposition amount control unit designates a high frequency superposition amount instruction value, which is determined by adding an offset value represented by one of the first high frequency superposition amount information and the second high frequency superposition amount information to the identified lower superposition amount instruction value, to the high frequency superposition unit.

(5) The optical recording medium driving apparatus according to any one of (1) to (4) above,

in which the evaluation signal generating unit generates a signal representing a β value as the evaluation signal.

(6) The optical recording medium driving apparatus according to any one of (1) to (4) above,

in which the evaluation signal generating unit generates a signal representing a modulation factor as the evaluation signal.

(7) The optical recording medium driving apparatus according to any one of (1) to (4) above,

in which the evaluation signal generating unit generates an RF signal as the evaluation signal.

It should be understood by those skilled in the art that various modifications, combinations, sub-combinations and alterations may occur depending on design requirements and other factors insofar as they are within the scope of the appended claims or the equivalents thereof.

What is claimed is:

1. An optical recording medium driving apparatus, comprising:
a driving signal generating unit configured to generate a driving signal for driving a laser beam source for emission;
a high frequency superposition unit configured to perform high frequency superposition on the driving signal;
a light receiving unit configured to receive an optical feedback of a laser beam, which has been emitted by the laser beam source, from an optical recording medium;
an evaluation signal generating unit configured to generate an evaluation signal based on a light reception signal from the light receiving unit, the evaluation signal being used as an evaluation indicator for signal quality, an accuracy of measurement of the evaluation signal being likely to become poor with increase in scoop ratio;
a storage unit configured to store, as high frequency superposition amount information for instructing a high frequency superposition amount to be implemented by the high frequency superposition unit, first high frequency superposition amount information corresponding to a high frequency superposition amount to be set for a normal reproduction mode and second high frequency superposition amount information corresponding to a high frequency superposition amount that is greater than that represented by the first high frequency superposition amount information; and
a superposition amount control unit configured to perform control so that a high frequency superposition amount based on the second high frequency superposition amount information is set to the high frequency superposition unit in response to when measuring an evaluation index based on the evaluation signal.

2. The optical recording medium driving apparatus according to claim 1, further comprising
a reproduction unit configured to reproduce recorded information on the optical recording medium based on the light reception signal,
wherein the superposition amount control unit performs control so that a high frequency superposition amount that is greater than the high frequency superposition amount to be set for the normal reproduction mode is set to the high frequency superposition unit in response to when the reproduction unit retries information reproduction.

3. The optical recording medium driving apparatus according to claim 1, further comprising
an automatic power control (APC) unit configured to adjust a level of the driving signal so that emission power of the laser beam is held constant,
wherein the superposition amount control unit identifies a lower superposition amount instruction value as a high frequency superposition amount instruction value at which the level of the driving signal turns to remain constant as the high frequency superposition amount instruction value of the high frequency superposition unit is lowered, and designates a high frequency superposition amount instruction value, that has been calculated based on the identified lower superposition amount instruction value and one of the first high frequency superposition amount information and the second high frequency superposition amount information, to the high frequency superposition unit.

4. The optical recording medium driving apparatus according to claim 3, wherein
the first high frequency superposition amount information and the second high frequency superposition amount information are information that are set as an offset value from the identified lower superposition amount instruction value, and
the superposition amount control unit designates a high frequency superposition amount instruction value, which is determined by adding an offset value represented by one of the first high frequency superposition amount information and the second high frequency superposition amount information to the identified lower superposition amount instruction value, to the high frequency superposition unit.

5. The optical recording medium driving apparatus according to claim 1,
wherein the evaluation signal generating unit generates a signal representing a β value as the evaluation signal.

6. The optical recording medium driving apparatus according to claim 1,
wherein the evaluation signal generating unit generates a signal representing a modulation factor as the evaluation signal.

7. The optical recording medium driving apparatus according to claim 1,
wherein the evaluation signal generating unit generates an RF signal as the evaluation signal.

8. A method of performing high frequency superposition on a driving signal for driving a laser beam source for emission, comprising
controlling so that, out of first high frequency superposition amount information corresponding to a high frequency superposition amount to be set for a normal reproduction mode as a high frequency superposition amount information for designating an amount of superposition to be performed on the driving signal and second high frequency superposition amount information corresponding to a high frequency superposition amount greater than the high frequency superposition amount represented by the first high frequency superposition amount information, in response to when measuring an evaluation index as an evaluation indicator for signal quality obtained based on a light reception signal for an optical feedback of a laser beam, that has been emitted by a laser beam source, from an optical recording medium, an accuracy of measurement of the evaluation index being likely to become poor with increase in scoop ratio, a high frequency superposition amount based on the second high frequency superposition amount information is set.

9. A program to be executed by an optical recording medium driving apparatus configured to perform high frequency superposition on a driving signal for driving a laser beam source for emission, the program causing the optical recording medium driving apparatus to execute the step of
controlling so that, out of first high frequency superposition amount information corresponding to a high frequency superposition amount to be set for a normal reproduction mode as a high frequency superposition amount information for designating an amount of superposition to be performed on the driving signal and second high frequency superposition amount information corresponding to a high frequency superposition amount greater than the high frequency superposition amount represented by the first high frequency superposition amount information, in response to when measuring an evaluation index as an evaluation indicator for signal quality obtained based on a light reception signal for an optical feedback of a laser beam, that has been emitted by a laser beam source, from an optical recording medium, an accuracy of measurement of the evaluation index being likely to become poor with increase in scoop ratio, a high frequency superposition amount based on the second high frequency superposition amount information is set.
